(19) United States
(12) Patent Application Publication
(10) Pub. No.: US 2021/0237095 A1
(43) Pub. Date: Aug. 5, 2021

(54) DOCUMENT MANAGEMENT SYSTEM, DOCUMENT MANAGEMENT METHOD, AND DOCUMENT PROCESSING APPARATUS

(71) Applicant: SEIKO EPSON CORPORATION, Tokyo (JP)

(72) Inventors: Yoshio MURATA, Matsumoto (JP); Yoshinobu MONBETSU, Matsumoto (JP)

(21) Appl. No.: 17/160,432

(22) Filed: Jan. 28, 2021

(30) Foreign Application Priority Data
Jan. 30, 2020 (JP) 2020-013338

(51) Int. Cl. B02C 18/00; B02C 18/22; B02C 25/00; G06K 7/14

(52) U.S. Cl. CPC B02C 18/0007; B02C 18/2225; B02C 2018/164; G06K 7/1408; B02C 25/00

(57) ABSTRACT

A sheet manufacturing system includes a sheet manufacturing apparatus that decomposes a document, and a server apparatus that manages a process status of the document, in which the sheet manufacturing apparatus includes a read unit that reads identification information attached to the document, a processing unit that decomposes the document the identification information of which was read by the read unit and that is determined to be suitable for a decomposing process, a determination unit that determines that the document was decomposed by the processing unit, and a first communication unit that transmits to the server apparatus the identification information of the document determined by the determination unit to have been decomposed by the processing unit.

The present application is based on, and claims priority from JP Application Serial Number 2020-013338, filed Jan. 30, 2020, the disclosure of which is hereby incorporated by reference herein in its entirety.

### BACKGROUND

### 1. Technical Field

The present disclosure relates to a document management system, a document management method, and a document processing apparatus.

### 2. Related Art

In the related art, a used paper cutting device that destroys paper on which personal information, confidential information, and the like are written to make the information described on the paper unrecognizable is known (see, for example, JP-A-2012-170870). The device described in JP-A-2012-170870 has a security function for preventing a theft of used paper set in a paper feeding unit.

A paper processing device having a function of validating that the set paper has been processed has not been proposed. Therefore, there has been a demand for a management method of managing that the information written on the paper has been erased.

### SUMMARY

According to an aspect of the present disclosure, a document management system includes a processing apparatus that decomposes a document, and a management apparatus that manages a process status of the document, in which the processing apparatus includes a read unit that reads identification information attached to the document, a processing unit that decomposes the document the identification information of which was read by the read unit and that is determined to be suitable for a decomposing process, a determination unit that determines that the document was decomposed by the processing unit, and a communication unit that transmits, to the management apparatus, identification information of the document determined by the determination unit to have been decomposed by the processing unit.

According to another aspect of the present disclosure, in a document management method in which a processing apparatus that decomposes a document and a management apparatus that manages a process status of the document are used, the method includes, by the processing apparatus, reading identification information attached to the document, decomposing the document the identification information of which was read, determining that the document was decomposed, and transmitting, to the management apparatus, the identification information of the document determined to have been decomposed.

According to still another aspect of the present disclosure, a document processing apparatus includes a read unit that reads identification information attached to a document, a processing unit that decomposes the document the identification information of which was read by the read unit, a determination unit that determines that the document was decomposed by the processing unit, and a communication unit that transmits the identification information of the document determined by the determination unit to have been decomposed by the processing unit.

### BRIEF DESCRIPTION OF THE DRAWINGS

FIG. 1 is a diagram showing a schematic configuration of a sheet manufacturing system according to a first embodiment.

FIG. 2 is a diagram showing a configuration of a sheet manufacturing apparatus.

FIG. 3 is a flowchart showing an example of a sheet manufacturing process.

FIG. 4 is a diagram showing a configuration of a sorting device.

FIG. 5 is an explanatory diagram of a reading operation by a reading unit.

FIG. 6 is a functional block diagram of the sheet manufacturing apparatus.

FIG. 7 is a functional block diagram of the sheet manufacturing system.

FIG. 8 is a sequence diagram showing an operation of the sheet manufacturing system.

FIG. 9 is a flowchart showing an operation of the sheet manufacturing apparatus.

FIG. 10 is a flowchart showing an operation of a server apparatus.

FIG. 11 is a flowchart showing the operation of the server apparatus.

FIG. 12 is a diagram showing an example of a configuration of a sheet manufacturing apparatus according to a second embodiment.

FIG. 13 is a functional block diagram of the sheet manufacturing apparatus of the second embodiment.

FIG. 14 is a functional block diagram of a sheet manufacturing apparatus of a third embodiment.

### DESCRIPTION OF EXEMPLARY EMBODIMENTS

Hereinafter, preferred embodiments of the present disclosure will be described in detail with reference to the drawings.

### 1. First Embodiment

### 1-1. Configuration of Sheet Manufacturing System

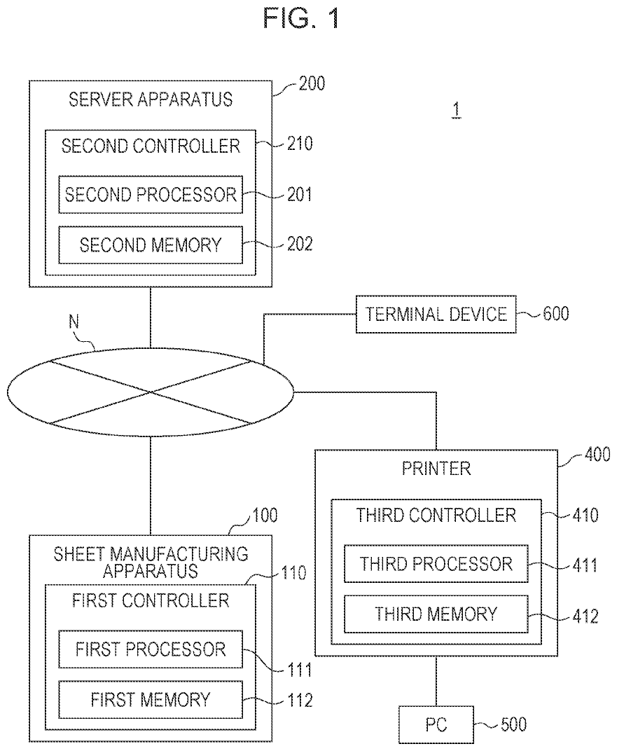

FIG. 1 is a diagram showing a schematic configuration of a sheet manufacturing system 1 according to the embodiment. The sheet manufacturing system 1 corresponds to, for example, a document management system. The sheet manufacturing system 1 includes a sheet manufacturing apparatus 100 and a server apparatus 200. The sheet manufacturing system 1 may include a printer 400. The server apparatus 200 can be connected to a terminal device 600, and the printer 400 is connected to a PC 500. The PC is an abbreviation for personal computer.

The sheet manufacturing apparatus 100 is a device that fiberizes a raw material containing fibers to manufacture a recycled sheet. Examples of the raw material used in the sheet manufacturing apparatus 100 may include any material containing fibers such as wood pulp material, kraft pulp, used paper, and synthetic pulp, and the raw material may preferably contain cellulose fibers. Further, the raw material may contain carbon fiber, metal fiber, and thixotropy fiber.

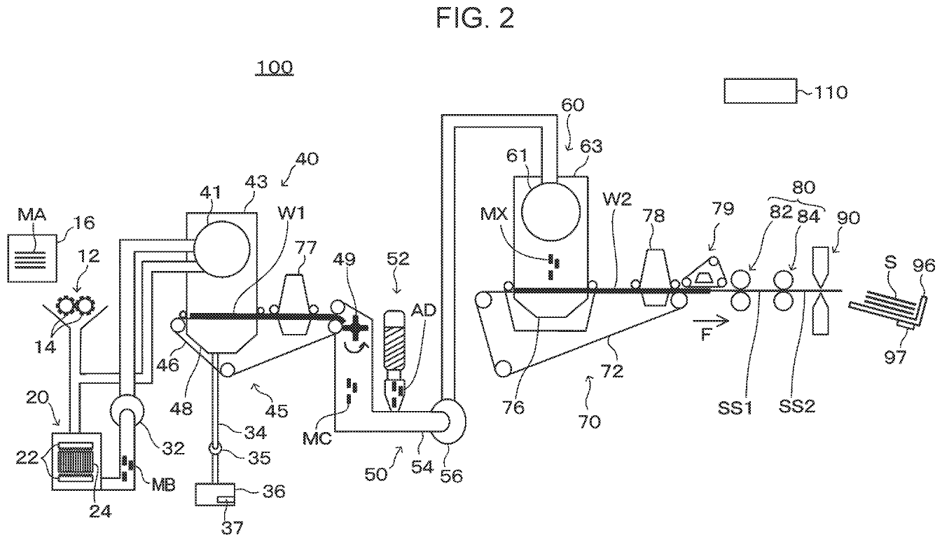

While details of the sheet manufactured by the sheet manufacturing apparatus 100 and the manufacturing process of the sheet will be described later with reference to FIG. 2, the sheet manufacturing apparatus 100 finely decomposes or destroys the raw material in the process of manufacturing the sheet. For example, when used paper is used as a raw material for the sheet manufacturing apparatus 100, the information printed on the used paper becomes unreadable and virtually disappears after the process by the sheet manufacturing apparatus 100. Therefore, the sheet manufacturing apparatus 100 can play a role as an apparatus for erasing information written on paper in addition to a role as an apparatus for reusing a raw material containing fibers. In the sheet manufacturing system 1, the sheet manufacturing apparatus 100 uses used paper as a raw material, and the server apparatus 200 functions as a device that manages whether the used paper is processed by the sheet manufacturing apparatus 100.

The sheet manufacturing apparatus 100 has a function of identifying the used paper one by one or a predetermined number of sheets as a unit by reading the information recorded on the used paper used as a raw material. As a method of recording the information read by the sheet manufacturing apparatus 100 on used paper, various methods can be used. Here, a configuration in which information readable by the sheet manufacturing apparatus 100 is printed when the printer 400 performs printing on paper is illustrated. The printer 400 is connected to the PC 500 and performs printing according to the control of the PC 500.

When performing printing, the printer 400 notifies the server apparatus 200 of the information printed on the paper. When the paper on which printing is performed by the printer 400 is supplied as used paper, and this used paper is processed, the sheet manufacturing apparatus 100 notifies the server apparatus 200 of information about the processed used paper. Therefore, in the sheet manufacturing system 1, the sheet manufacturing apparatus 100 and the printer 400 are connected to the server apparatus 200 via a communication network N.

The server apparatus 200 manages the process status of the used paper processed by the sheet manufacturing apparatus 100. The server apparatus 200 may have a configuration capable of outputting the process status of used paper to another device. As shown in FIG. 1, the present embodiment shows, for example, a configuration in which the server apparatus 200 is connected to the terminal device 600 via the communication network N. The terminal device 600 is, for example, a terminal device used by an operator who manages or operates the sheet manufacturing apparatus 100, and is a device such as a personal computer, a smartphone, and a portable telephone. The server apparatus 200 outputs information about the process status of used paper to the terminal device 600. The server apparatus 200 corresponds to, for example, a management apparatus.

The communication network N is a data communication network that enables data communication between a plurality of devices. It may be an open network such as the Internet, or may be a closed network. The communication network N includes, for example, communication lines such as a LAN, a public network, and a dedicated line, and may include various devices (not shown) such as a router and a server. The LAN is an abbreviation for local area network.

As a configuration example for achieving the above configuration, the sheet manufacturing apparatus 100 includes a first controller 110 that controls the operation of the sheet manufacturing apparatus 100, and the first controller 110 includes a first processor 111 and a first memory 112. The first processor 111 is an arithmetic processing apparatus composed of a CPU and an MPU. The first processor 111 executes a control program to control respective units of the sheet manufacturing apparatus 100. The first processor 111 may be configured by a single processor, or may be configured by a plurality of processors. It may be configured by a SoC integrated with various circuits including a semiconductor storage element. Further, all the functions of the first processor 111 may be implemented by hardware, or the first processor 111 may be configured by including a programmable device. The CPU is an abbreviation for central processing unit, the MPU is an abbreviation for micro processing unit, and the SoC is an abbreviation for system on a chip. The first memory 112 is a storage device that stores a program executed by the first processor 111, data processed by the first processor 111, and the like. The first memory 112 may be a temporary storage device that forms a work area and temporarily stores data and programs, and may be, for example, a RAM. The first memory 112 may be a non-volatile storage device that non-volatilely stores programs and data, and may be configured by, for example, a semiconductor storage element such as a flash ROM, or a magnetic storage device. Further, the first memory 112 may be configured by combining both the temporary storage device and the non-volatile storage device. The RAM is an abbreviation for random access memory, and the ROM is an abbreviation for read only memory.

The server apparatus 200 receives and processes the information transmitted from the sheet manufacturing apparatus 100 and the printer 400, thereby managing the process status of the used paper processed by the sheet manufacturing apparatus 100. The server apparatus 200 includes a second controller 210 including a second processor 201 and a second memory 202. The second processor 201 is an arithmetic processing apparatus composed of a CPU and an MPU. The second processor 201 executes a control program to control respective units of the server apparatus 200. As in the first processor 111, the second processor 201 can be configured by a single processor or a plurality of processors, and may be configured by a SoC. Further, all the functions of the second processor 201 may be implemented by hardware, or the second processor 201 may be configured by including a programmable device. The second memory 202 is a storage device that stores a program executed by the second processor 201, data processed by the second processor 201, and the like. The second memory 202 may be a temporary storage device that forms a work area and temporarily stores data and programs, and may be, for example, a RAM. The second memory 202 may be a non-volatile storage device that non-volatilely stores programs and data, and may be configured by, for example, a semiconductor storage element such as a flash ROM, or a magnetic storage device. Further, the second memory 202 may be configured by combining both the temporary storage device and the non-volatile storage device.

The printer 400 performs printing on paper according to the print information transmitted by the PC 500. Examples of the print medium used by the printer 400 may include a sheet made of synthetic resin in addition to paper. The print medium may be a continuous sheet such as roll paper, or may be cut paper cut to a standard size. In the embodiment, PPC paper with a standard size is exemplified. The PPC is an abbreviation for plain paper copier. The printer 400 corresponds to, for example, the printing device of the present disclosure.

The printer 400 includes a third controller 410 that controls respective units of the printer 400, and the third controller 410 includes a third processor 411 and a third memory 412. The third processor 411 is an arithmetic processing apparatus composed of a CPU and an MPU. The third processor 411 executes a control program to control respective units of the printer 400. As in the first processor 111, the third processor 411 can be configured by a single processor or a plurality of processors, and may be configured by a SoC. Further, all the functions of the third processor 411 may be implemented by hardware, or may be configured by including a programmable device. The third memory 412 is a storage device that stores a program executed by the third processor 411, data processed by the third processor 411, and the like. The third memory 412 may be a temporary storage device that forms a work area and temporarily stores data and programs, and may be, for example, a RAM. The third memory 412 may be a non-volatile storage device that non-volatilely stores programs and data, and may be configured by, for example, a semiconductor storage element such as a flash ROM, or a magnetic storage device. Further, the third memory 412 may be configured by combining both the temporary storage device and the non-volatile storage device.

### 1-2. Configuration of Sheet Manufacturing Apparatus

FIG. 2 is a diagram showing the configuration of the sheet manufacturing apparatus 100. The sheet manufacturing apparatus 100 fiberizes a raw material MA to manufacture a sheet S. The sheet manufacturing apparatus 100 includes a coarse crushing unit 12, a defibration unit 20, a transport blower 32, a separation unit 40, a first web forming unit 45, a rotating body 49, a mixing unit 50, a dispersion unit 60, and a second web forming unit 70, a web transport unit 79, a process unit 80, and a cutting unit 90.

The sheet manufacturing apparatus 100 corresponds to, for example, a processing apparatus and a document processing apparatus. The processing apparatus corresponds to an apparatus including part or all of the structure of the coarse crushing unit 12, the defibration unit 20, the transport blower 32, the separation unit 40, the first web forming unit 45, the rotating body 49, the mixing unit 50, the dispersion unit 60, the second web forming unit 70, and the web transport unit 79, the process unit 80, and the cutting unit 90. The sheet manufacturing apparatus 100 includes a sorting device 16 that supplies the raw material MA.

The raw material MA used in the sheet manufacturing apparatus 100 is a sheet-like material containing cellulose fibers as described above, and is used paper in the present embodiment. The used paper is paper, such as PPC paper, on which characters and images are printed by a printer or a printing machine, and is supplied to the sheet manufacturing apparatus 100 for the purpose of disposal. The raw material MA corresponds to a document.

The sorting device 16 sorts the raw materials MA into a raw material MA suitable for the process by the sheet manufacturing apparatus 100 and a raw material MA that is not suitable for the process, and supplies the raw material MA suitable for the process to the coarse crushing unit 12. Examples of the raw material MA that is not suitable for the process include, for example, paper that is significantly damaged or deformed, paper that does not fit in size, paper whose thickness exceeds the limit, paper to which a stapler metal needle or a paper clip is attached, paper that is stuck to other paper, and the like. The paper that is significantly damaged or deformed is, specifically, paper having wrinkles, tears, stains, and buckling causing its shape to be clearly different from that of another raw material MA. The paper that does not fit in size is, specifically, paper whose size deviates from the size range of the raw material MA, which can be processed by the sheet manufacturing apparatus 100. These types of paper are not suitable for the process because they may cause clogging in the path from the sorting device 16 to the coarse crushing unit 12 or in the subsequent transport path. The paper whose thickness exceeds the limit, and the paper that is stuck to other paper may cause trouble in the operation of the coarse crushing unit 12 or the defibration unit 20 due to their high hardness, and a large amount of defibrated product MB may be generated by defibration in the defibration unit 20 to cause clogging of the defibrated product MB, so that they are not suitable for the process. The paper to which a stapler metal needle or a paper clip is attached is not suitable for the process because the metal needle or the paper clip may affect the operation of the coarse crushing unit 12 or the defibration unit 20. The sorting device 16 transports the remaining raw material MA excluding the raw material MA that is not suitable for the process to the coarse crushing unit 12. In addition, the sorting device 16 collects the raw material MA that is not suitable for the process. The configuration of the sorting device 16 will be described later.

The coarse crushing unit 12 is a shredder that cuts the raw material MA with a coarse crushing blade 14. The raw material MA cut by the coarse crushing unit 12 is transported to the defibration unit 20 through a pipe.

The defibration unit 20 defibrates the fine pieces cut by the coarse crushing unit 12 in a dry process to produce the defibrated product MB. The defibration refers to a process of unraveling the raw material MA in a state where a plurality of fibers is bound into one or a small number of fibers. The dry process means that the defibration or the like is performed in the air such as in the atmosphere, not in the liquid. The defibrated product MB includes the fibers contained in the raw material MA. In addition, the defibrated product MB may include a substance other than the fibers contained in the raw material MA. For example, when used paper is used as the raw material MA, the defibrated product MB contains components such as resin grains, coloring agents such as ink and toner, bleeding preventive materials, and paper strength enhancers.

The defibration unit 20 is a mill including, for example, a stator 22 of a tubular shape and a rotor 24 that rotates inside the stator 22, and pinches the coarsely crushed piece between the stator 22 and the rotor 24 to defibrate the pinched coarsely crushed piece. The transport blower 32 is disposed downstream of the defibration unit 20 to generate an air flow. The defibrated product MB is transported to the separation unit 40 through a pipe by the air flow generated by the transport blower 32.

The fibers contained in the raw material MA or the fibers contained in the defibrated product MB have a fiber length of 0.1 mm or more and 100 mm or less, and preferably 0.5 mm or more and 50 mm or less. Further, these fibers have a fiber diameter of 0.1 μm or more and 1000 μm or less, and preferably 1 μm or more and 500 μm or less. Further, these fibers may contain a plurality of types of fibers, and may contain fibers in which at least one of the fiber length and the fiber diameter is different.

The raw material MA is cut into coarsely crushed pieces by the coarse crushing unit 12, and further decomposed into fibers by the defibration unit 20. Therefore, the characters and images written on the raw material MA become unreadable after being processed by the coarse crushing unit 12. Further, when the raw material MA is processed by the defibration unit 20, the characters and images written on the raw material MA become completely unreadable and cannot be recovered. Therefore, the information described in the raw material MA by printing, writing, or the like is erased by the defibration unit 20. The defibration unit 20 corresponds to, for example, a processing unit. The rough coarse crushing unit 12 may be included in the processing unit. Further, the coarse crushing unit 12 may be an example of the processing unit.

The separation unit 40 includes a drum unit 41 and a housing unit 43 that houses the drum unit 41. The drum unit 41 is a sieve having openings, such as a net, a filter, and a screen, and is rotated by the power of a motor (not shown). The defibrated product MB is unraveled inside the rotating drum unit 41, passes through the openings of the drum unit 41, and descends. Among the components of the defibrated product MB, those that do not pass through the openings of the drum unit 41 are transported to the defibration unit 20 through the pipe.

The first web forming unit 45 includes an endless mesh belt 46 having a large number of openings. The first web forming unit 45 manufactures a first web W1 by accumulating fibers and the like descending from the drum unit 41 on the mesh belt 46. Among the components descending from the drum unit 41, those smaller than the openings of the mesh belt 46 pass through the mesh belt 46 and are suction-removed by a suction unit 48.

A waste powder collecting unit 36 is coupled to the suction unit 48 through a collection pipe 34. A collection blower 35 that sends the air sucked by the suction unit 48 to the waste powder collecting unit 36 is disposed in the collection pipe 34. Particles and the like that have passed through the mesh belt 46 are sent from the suction unit 48 to the waste powder collecting unit 36 by the air flow generated by the collection blower 35. The waste powder collecting unit 36 includes a filter (not shown) and collects particles and the like that have passed through the mesh belt 46. The waste powder collecting unit 36 collects, among the components of the defibrated product MB, short fibers which are not suitable for producing the sheet S, resin grains, ink, toner, bleeding preventive agent, and the like. A collection amount sensor 37 is disposed in the waste powder collecting unit 36. The collection amount sensor 37 is a sensor that detects the amount of the collected materials collected by the waste powder collecting unit 36. Specifically, the collection amount sensor 37 is a weight sensor that detects the weight of the filter of the waste powder collecting unit 36, an optical sensor that detects the thickness of the materials collected and accumulated on the filter of the waste powder collecting unit 36, and an optical sensor that detects the area of the region where the collected material is attached in the filter of the waste powder collecting unit 36, and the like. The collection amount sensor 37 has a function of detecting the collected material, which is a discharged material discharged by the defibration unit 20, and corresponds to, for example, a discharge detection unit.

A humidifying unit 77 is disposed in the migration path of the mesh belt 46, and the first web W1 accumulated on the mesh belt 46 is humidified by mist-like water or high-humidity air. The first web W1 is transported by the mesh belt 46 and comes into contact with the rotating body 49. The rotating body 49 divides the first web W1 by a plurality of blades to form a fiber material MC. The fiber material MC is transported to the mixing unit 50 through a pipe 54.

The mixing unit 50 includes an additive supply unit 52 that adds an additive material AD to the fiber material MC, and a mixing blower 56 that mixes the fiber material MC and the additive material AD. The additive material AD binds fibers by cross-linking a plurality of fibers to each other to make the fibers into a sheet shape. The additive material AD includes a resin that functions as a binding material that binds the fibers to each other, and, in particular, includes at least one of a thermoplastic resin and a thermosetting resin. The additive material AD may include a thermoplastic core-sheath resin. Further, the additive material AD may include a colorant, an aggregation inhibitor, a flame retardant and the like in addition to the above resin.

The additive supply unit 52 includes a tank that stores the additive material AD, and sends the additive material AD from the tank to the pipe 54 under the control of the first controller 110. The mixing blower 56 generates an air flow in the pipe 54 through which the fiber material MC and the additive material AD are transported, mixes the fiber material MC with the additive material AD, and transports a mixture MX to the dispersion unit 60.

The dispersion unit 60 includes a drum unit 61 and a housing unit 63 that houses the drum unit 61. The drum unit 61 is a cylindrical sieve having the same structure as the drum unit 41, and is driven by a motor (not shown) to rotate. The mixture MX is unraveled by the rotation of the drum unit 61 and descends inside the housing unit 63.

The second web forming unit 70 includes an endless mesh belt 72 having a large number of openings. The second web forming unit 70 manufactures a second web W2 by accumulating the mixture MX descending from the drum unit 61 on the mesh belt 72. Among the components of the mixture MX, those smaller than the openings of the mesh belt 72 pass through the mesh belt 72 and are sucked by a suction unit 76.

A humidifying unit 78 is disposed in the migration path of the mesh belt 72, and the second web W2 accumulated on the mesh belt 72 is humidified by mist-like water or high-humidity air.

The second web W2 is peeled off from the mesh belt 72 by the web transport unit 79 and transported to the process unit 80. The process unit 80 includes a pressurizing unit 82 and a heating unit 84. The pressurizing unit 82 pinches the second web W2 with a pair of pressurizing rollers and pressurizes the pinched second web W2 with a predetermined nip pressure to form a post-pressure sheet SS1. The heating unit 84 applies heat by pinching the post-pressure sheet SS1 with a pair of heating rollers. As a result, the fibers included in the post-pressure sheet SS1 are bound by the resin included in the additive material AD, and a post-heating sheet SS2 is formed. The post-heating sheet SS2 is transported to the cutting unit 90.

The cutting unit 90 cuts the post-heating sheet SS2 in a direction intersecting a transport direction F to manufacture the sheet S having a predetermined size. The sheet S is stored in a discharge unit 96. A paper discharge quantity sensor 97 that detects the quantity of the sheets S stored in the discharge unit 96 is disposed in the discharge unit 96. The paper discharge quantity sensor 97 is, for example, a weight sensor that detects the weight of the sheets S accumulated in the discharge unit 96, an optical sensor or a switch type sensor that detects the thickness of the sheets S accumulated in the discharge unit 96, or the like.

In the embodiment, the sheet manufacturing apparatus 100 fiberizes the raw material MA in a dry process to manufacture the sheet S. The sheet manufacturing apparatus 100 may fiberize the raw material MA in a wet process to manufacture the sheet S. A sheet manufacturing apparatus that manufactures the sheet S by fiberizing the raw material MA in a wet process is described in, for example, JP-A-2011-137251. For example, the used paper processing apparatus described in JP-A-2011-137251 includes a recycled pulp unit, a deinked pulp unit, a papermaking unit, a finishing unit, and a wastewater processing unit. In this configuration, the recycled pulp unit prepares recycled pulp by separating a piece of cut paper from used paper with a pulper, and corresponds to, for example, a processing unit.

### 1-3. Sheet Manufacturing Process

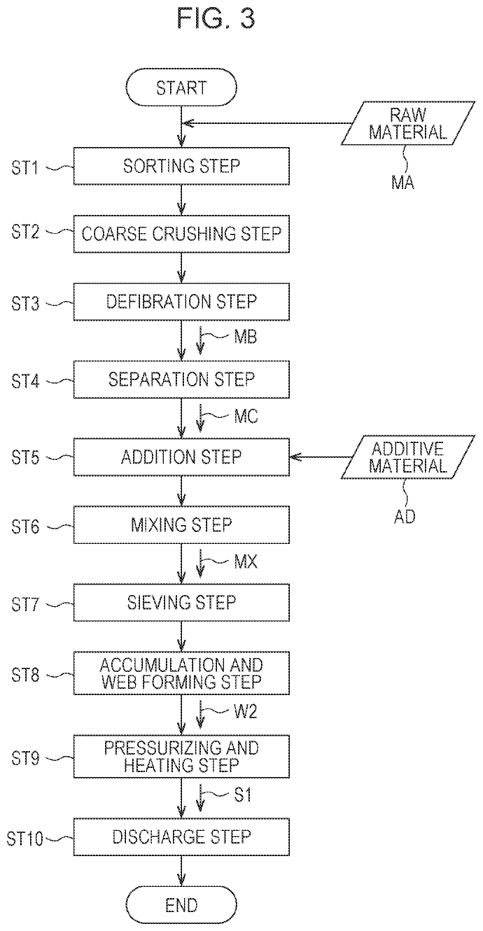

FIG. 3 is a flowchart showing an example of the manufacturing process of the sheet S by the sheet manufacturing apparatus 100. Used paper as a raw material MA is supplied to the sheet manufacturing apparatus 100. Step ST1 is a sorting step of sorting out the raw material MA suitable for the process by the sheet manufacturing apparatus 100 from the supplied raw material MA. The sorting step corresponds to, for example, a process by the sorting device 16. Step ST2 is a coarse crushing step of coarsely crushing the raw material MA, and corresponds to, for example, a process by the rough coarse crushing unit 12 of the sheet manufacturing apparatus 100. The coarse crushing step is a step of cutting the raw material MA to a sheet with a predetermined size or less.

Step ST3 is a defibration step, and corresponds to, for example, a process by the defibration unit 20 of the sheet manufacturing apparatus 100. Step ST4 is a step of extracting a material mainly composed of fibers from the defibrated product MB, and is referred to as a separation step. The separation step is a step of separating particles such as resin and additives from the defibrated product MB including fibers and resin particles, and taking out a material including fibers as a main component. The separation step corresponds to, for example, a process by the separation unit 40 and the rotating body 49 of the sheet manufacturing apparatus 100.

When the raw material MA supplied in step ST2 does not include particles or the like that affect the production of the sheet S, or when it is not necessary to remove particles or the like from the components contained in the raw material MA, the separation step of step ST4 can be omitted. In this case, the defibrated product MB is used as it is as the fiber material MC.

Step ST5 is an addition step, which is a step of adding the additive material AD to the fiber material MC separated in step ST4. The addition step corresponds to, for example, a process by the additive supply unit 52 of the sheet manufacturing apparatus 100.

Step ST6 is a mixing step, which is a step of mixing the fiber material MC with the additive material AD to manufacture the mixture MX. The mixing step corresponds to, for example, a process by the mixing unit 50 of the sheet manufacturing apparatus 100.

Step ST7 is a sieving step, which is a step of sieving the mixture MX to disperse the sieved mixture MX in the atmosphere to descend the dispersed mixture MX. The sieving step corresponds to, for example, a process by the dispersion unit 60 of the sheet manufacturing apparatus 100.

Step ST8 is an accumulation step, which is a step of accumulating the mixture MX that descends in the sieving step of step ST7 to form a web. The accumulation step corresponds to, for example, a process of forming the second web W2 by the second web forming unit 70 of the sheet manufacturing apparatus 100.

Step ST9 is a pressurizing and heating step, which is a step of pressurizing and heating the web. The pressurizing and heating step corresponds to, for example, a process of heating and pressurizing the second web W2 by the process unit 80 of the sheet manufacturing apparatus 100 to form the sheet S after forming the post-pressure sheet SS1 and the post-heating sheet SS2. The order of pressurization and heating in the pressurizing and heating step is not limited, but it is preferable that pressurization is performed before heating.

Step ST10 is a discharge step of discharging the sheet S. The discharge step corresponds to, for example, an operation of discharging the sheet S to the discharge unit 96.

### 1-4. Configuration of Sorting Device

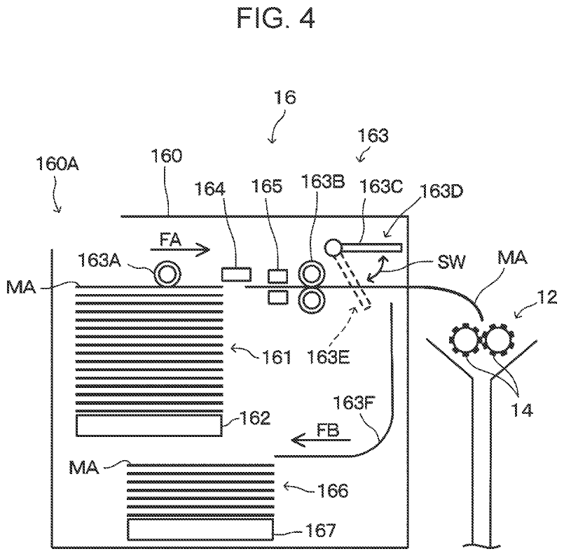

FIG. 4 is a diagram showing an example of the configuration of the sorting device 16. The sorting device 16 includes a housing 160 and a raw material accommodation unit 161 provided inside the housing 160. The sorting device 16 corresponds to, for example, a sorting unit.

The raw material accommodation unit 161 accommodates the raw material MA input from an input port 160A provided in the housing 160. A raw material amount sensor 162 is disposed in the raw material accommodation unit 161. The raw material amount sensor 162 is a sensor that detects the amount of the raw materials MA accommodated in the raw material accommodation unit 161, and, for example, is a weight sensor that detects the weight of the raw materials MA accumulated in the raw material accommodation unit 161. The raw material amount sensor 162 may be an optical sensor or a switch type sensor that detects the accumulated height of the raw materials MA accumulated in the raw material accommodation unit 161. The input port 160A may have a lid that can be opened/closed, and the lid may be locked by a locking mechanism.

The housing 160 has a collection tray 166. The collection tray 166 accommodates the raw material MA that is not suitable for the process by the sheet manufacturing apparatus 100. A collected quantity sensor 167 is disposed at the collection tray 166. The collected quantity sensor 167 is a sensor that detects the amount of the raw materials MA accommodated in the collection tray 166, and, for example, is a weight sensor that detects the weight of the raw materials MA accumulated on the collection tray 166. The collected quantity sensor 167 may be an optical sensor or a switch type sensor that detects the accumulated height of the raw materials MA accumulated in the collection tray 166.

The sorting device 16 includes a transport unit 163 as a unit that transports the raw material MA. The transport unit 163 includes a pickup roller 163A, a supply roller 163B, a switching arm 163C, and a guide 163F. The pickup roller 163A takes out the raw material MA from the raw material accommodation unit 161. The supply roller 163B is composed of a pair of rollers that rotate while nipping the raw material MA, and transports the raw material MA taken out by the pickup roller 163A.

The switching arm 163C is an arm that can be displaced to a supply position 163D and a sorting position 163E, and may be rod-shaped or plate-shaped. The switching arm 163C switches the transport path of the raw material MA sent out by the supply roller 163B between a path toward the coarse crushing unit 12 and a path toward the collection tray 166. The switching arm 163C guides the raw material MA sent out by the supply roller 163B toward the coarse crushing unit 12 in a state of being located at the supply position 163D. The switching arm 163C deviates the raw material MA from the path toward the coarse crushing unit 12 in a state of being located at the sorting position 163E. The guide 163F guides the raw material MA deviating from the path toward the coarse crushing unit 12 to the collection tray 166.

The raw material MA is transported by the pickup roller 163A in the direction indicated by reference numeral FA in the drawing to reach the supply roller 163B. A reading unit 164 and a raw material inspection unit 165 are disposed in a transport path between the pickup roller 163A and the supply roller 163B.

The reading unit 164 is a device that reads the identification information written on the raw material MA, and, for example, is a scanner that optically reads characters, images, barcodes, two-dimensional codes, or the like indicating identification information. Further, when the identification information attached to the raw material MA is characters or the like printed with magnetic ink, a magnetic sensor can be used as the reading unit 164.

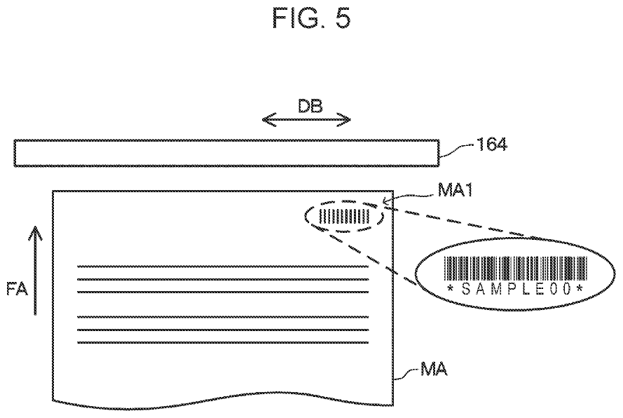

FIG. 5 is an explanatory diagram of a reading operation by the reading unit 164, and is a plan view of a main part of the sorting device 16 including the reading unit 164. In the example of FIG. 5, an identification information code MA1 is attached to the raw material MA. The raw material MA is a document on which characters and images are printed by the printer 400, and when the printer 400 prints characters and images, which are the contents of a document, it prints the identification information code MA1 at the same time. Although the identification information code MA1 is a barcode in the example of FIG. 5, the code which the reading unit 164 can read will suffice, and it may be a two-dimensional code or an image code, or may be a character.

The reading unit 164 is an optical scanner composed of a CMOS image sensor, a CCD sensor, or the like. The reading unit 164 is disposed along a width direction DB of the raw material MA, and reads the identification information code MA1 recorded on the surface of the raw material MA transported in the direction FA. The reading unit 164 may be disposed at both the position corresponding to the front surface of the raw material MA and the position corresponding to the back surface of the raw material MA, or may be disposed only on the back surface side of the raw material MA. The reading unit 164 outputs data indicating a reading result to the first controller 110. The reading unit 164 corresponds to, for example, a read unit.

Returning to FIG. 4, the raw material inspection unit 165 performs detection to determine whether the raw material MA is suitable for the process by the sheet manufacturing apparatus 100 to output the detected value to the first controller 110. The raw material inspection unit 165 is located, for example, downstream of the reading unit 164 and upstream of the switching arm 163C in the transport path of the raw material MA.

The raw material inspection unit 165 can be configured to detect the size of the raw material MA, the damage of the raw material MA, the thickness of the raw material MA, the number of sheets of the raw material MA, the metal attached to the raw material MA, and the hardness of the raw material MA. The raw material inspection unit 165 may be an optical sensor that detects the outer shape of the raw material MA, and in this case, the size and buckling of the raw material MA can be detected. Further, the raw material inspection unit 165 may be configured to detect the thickness of the raw material MA as an optical sensor that optically detects the thickness of the raw material MA. For example, the raw material inspection unit 165 may be composed of a transmission type optical sensor, and may detect the thickness of the raw material MA based on the amount of light transmitted through the raw material MA. Further, for example, the raw material inspection unit 165 may include two rollers that pinch the raw material MA and a distance sensor that measures the distance between the two rollers, and may be configured to detect the thickness of the raw material MA by the distance between the rollers. Further, the raw material inspection unit 165 may be composed of an ultrasonic sensor to detect that the number of sheets of the raw material MA is plural. In this case, the raw material inspection unit 165 can detect double feeding, which is a phenomenon in which a plurality of sheets of the raw material MA is collectively transported by the pickup roller 163A. Further, a magnetic material sensor or a metal sensor may be used as the raw material inspection unit 165 to detect the metal attached to the raw material MA. Further, the raw material inspection unit 165 may be provided with a lever-type sensor that presses the raw material MA, and may be configured to detect the hardness of the raw material MA based on the displacement amount of the lever. These are examples, and the raw material inspection unit 165 may be configured by a combination of a plurality of sensors.

After the raw material MA passes through the raw material inspection unit 165, it reaches the installation position of the switching arm 163C. Here, when the first controller 110 moves the switching arm 163C to the sorting position 163E, the raw material MA is guided by the guide 163F and moves in the direction indicated by the symbol FB to be accommodated in the collection tray 166. Further, under the control of the first controller 110, when the switching arm 163C moves to the supply position 163D, the raw material MA is transported to the coarse crushing unit 12 by the power of the supply roller 163B, and is cut by the coarse crushing blade 14.

### 1-5. Control System of Sheet Manufacturing Apparatus

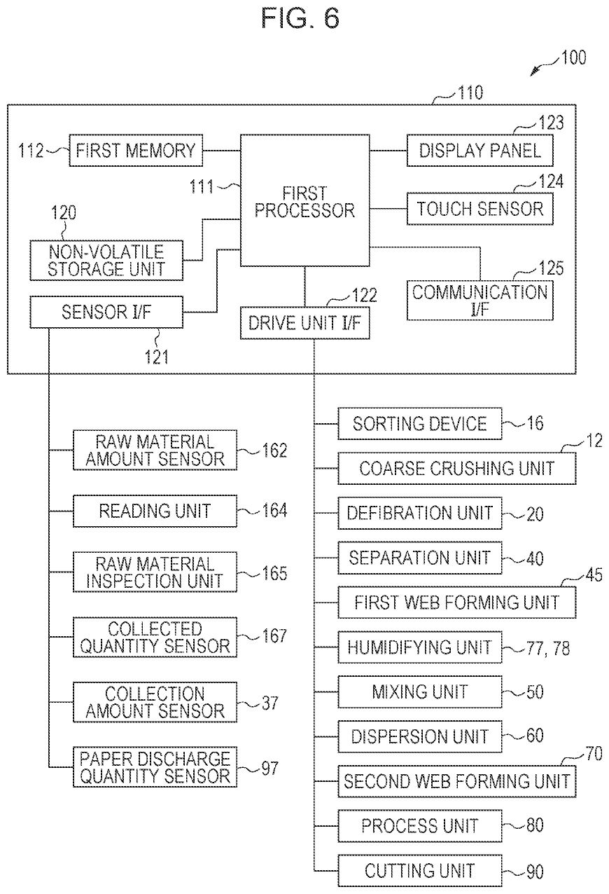

FIG. 6 is a functional block diagram of the sheet manufacturing apparatus 100. The sheet manufacturing apparatus 100 includes the first controller 110 mentioned above, and has a configuration in which various sensors and drive units are coupled to the first controller 110. The first controller 110 includes the first processor 111, the first memory 112, a non-volatile storage unit 120, a sensor I/F 121, a drive unit I/F 122, a display panel 123, a touch sensor 124, and a communication I/F 125. The I/F is an abbreviation for interface.

The non-volatile storage unit 120 stores various programs executed by the first processor 111 and various pieces of data processed by the first processor 111. The display panel 123 is, for example, a liquid crystal display panel, and is installed on the exterior of the sheet manufacturing apparatus 100. The display panel 123 displays the operating state of the sheet manufacturing apparatus 100, various set values, warning displays, and the like under the control of the first processor 111.

The touch sensor 124 detects a touch operation or a pressing operation by the user. The touch sensor 124 is, for example, disposed so as to overlap the display face of the display panel 123 and detects an operation on the display panel 123. The touch sensor 124 outputs operation data including the operation position and the number of operation positions to the first processor 111 in response to the user's operation.

The communication I/F 125 executes data communication through the communication network N under the control of the first processor 111. The communication I/F 125 may be a communication unit including a connector to which a communication cable is coupled and a communication interface circuit. Further, the communication I/F 125 may be a wireless communication module having an antenna and a wireless communication circuit.

The first controller 110 is coupled to the sensors installed in respective units of the sheet manufacturing apparatus 100 via the sensor I/F 121. The sensor I/F 121 is an interface circuit that acquires a detected value output by the sensor and inputs the acquired detected value to the first processor 111. The sensor I/F 121 may include an A/D converter that converts an analog signal output by the sensor into digital data. Further, the sensor I/F 121 may supply drive power to respective sensors. Further, the sensor I/F 121 may acquire the output value of each sensor according to the sampling frequency specified by the first processor 111, and may include a circuit that outputs the acquired output value to the first processor 111.

The raw material amount sensor 162, the reading unit 164, the raw material inspection unit 165, the collected quantity sensor 167, the collection amount sensor 37, and the paper discharge quantity sensor 97 are coupled to the sensor I/F 121. Various sensors (not shown in FIG. 6) may be coupled to the sensor I/F 121.

The first controller 110 is coupled to respective drive units included in the sheet manufacturing apparatus 100 via the drive unit I/F 122. The drive units included in the sheet manufacturing apparatus 100 are a motor, a pump, a heater, and the like. Instead of being directly coupled to the motor, the drive unit I/F 122 may be coupled to a drive circuit or a drive IC that supplies a drive current to the motor under the control of the first controller 110. The IC is an abbreviation for integrated circuit.

The sorting device 16, the coarse crushing unit 12, the defibration unit 20, the separation unit 40, the first web forming unit 45, the humidifying units 77 and 78, the mixing unit 50, the dispersion unit 60, and the second web forming unit 70, the process unit 80, the cutting unit 90, and the like which are to be controlled by the first controller 110 are coupled to the drive unit I/F 122.

The sorting device 16 includes drive units such as a motor that rotates the pickup roller 163A and the supply roller 163B, an actuator that displaces the switching arm 163C. The coarse crushing unit 12 includes a drive unit such as a motor that rotates the coarse crushing blade 14. The defibration unit 20 includes drive units such as a motor that rotates the rotor 24 and a motor that drives the transport blower 32.

The separation unit 40 includes a drive unit such as a motor that rotates the drum unit 41, and the first web forming unit 45 includes a drive unit such as a motor that rotates the mesh belt 46. The humidifying units 77 and 78 include a drive unit such as a fan that sends out mist-like water or high-humidity air. The mixing unit 50 includes a drive unit such as a motor that drives the mixing blower 56. The dispersion unit 60 includes a drive unit such as a motor that rotates the drum unit 61. The second web forming unit 70 includes a drive unit such as a motor that rotates the mesh belt 72. The process unit 80 includes a drive unit that drives the pressurizing unit 82 and the heating unit 84, a heat source that heats the heating unit 84, and the like. The cutting unit 90 includes a drive unit such as a motor that operates a blade that cuts the post-heating sheet SS2. Further, various drive units (not shown in FIG. 6) may be coupled to the drive unit I/F 122.

### 1-6. Configuration of Sheet Manufacturing System

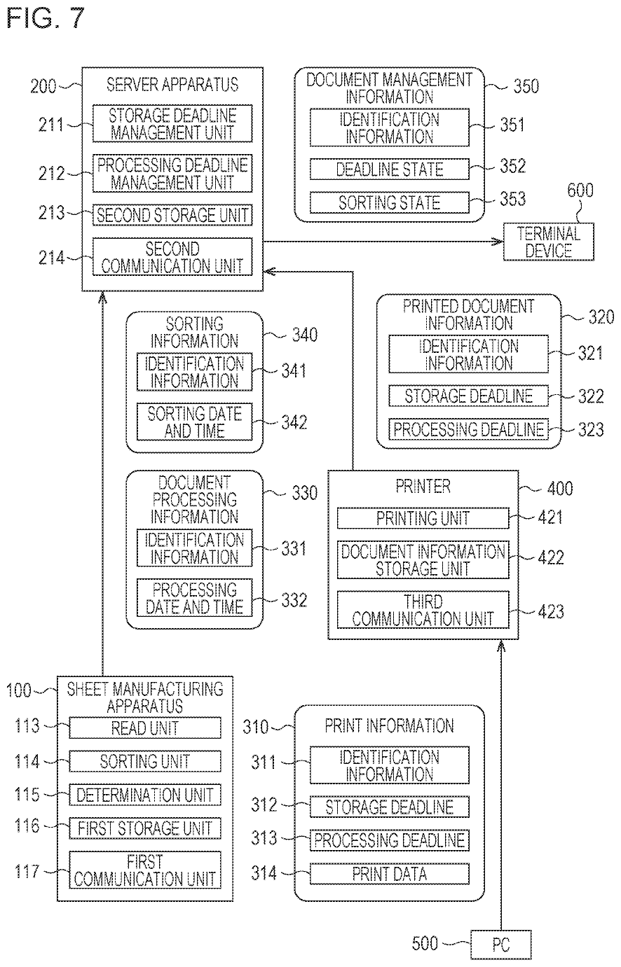

FIG. 7 is a functional block diagram of the sheet manufacturing system 1, and additionally shows information transmitted and received by respective units of the sheet manufacturing system 1. The sheet manufacturing apparatus 100 includes a read unit 113, a sorting unit 114, a determination unit 115, a first storage unit 116, and a first communication unit 117 as functional units configured by the first controller 110. The function of each of these units is implemented by the cooperation between the hardware and the software when the first processor 111 executes the program. The function of the sorting unit 114 is implemented by the first processor 111 controlling the sorting device 16. The function of the first storage unit 116 is implemented by using the storage area of the first memory 112 or the non-volatile storage unit 120. The function of the first communication unit 117 is implemented by the first processor 111 controlling the communication I/F 125.

The read unit 113 controls the reading unit 164 to read the identification information code MA1 recorded on the raw material MA to acquire the identification information of the raw material MA based on the reading result. The sorting unit 114 acquires the detected value output by the raw material inspection unit 165. The sorting unit 114 determines whether the raw material MA is suitable for the process by the sheet manufacturing apparatus 100 based on the detected value output by the raw material inspection unit 165. When the sorting unit 114 determines that the raw material MA is suitable for the process by the sheet manufacturing apparatus 100, the sorting unit 114 positions the switching arm 163C at the supply position 163D to send the raw material MA to the defibration unit 20. Further, when the sorting unit 114 determines that the raw material MA is not suitable for the process by the sheet manufacturing apparatus 100, the sorting unit 114 displaces the switching arm 163C to the sorting position 163E to send the raw material MA to the collection tray 166. The sorting unit 114 identifies the identification information of the raw material MA collected in the collection tray 166 based on the reading result of the read unit 113.

The determination unit 115 determines whether the raw material MA has been processed by the defibration unit 20. The determination unit 115 acquires the detected values output by the raw material amount sensor 162 at reference time T1 and time T2 when the set time has elapsed from time T1. The determination unit 115 calculates the quantity or the number of sheets of the raw material MA transported from the raw material accommodation unit 161 by the pickup roller 163A based on the change in the detected values from time T1 to T2. The determination unit 115 acquires the detected values output by the collection amount sensor 37 at time T1 and time T2 to calculate the amount of change in the collected materials collected in the waste powder collecting unit 36 based on the change in the detected values from time T1 to T2. The determination unit 115 calculates the number of raw materials MA defibrated by the defibration unit 20 between times T1 and T2 based on the quantity or the number of sheets of the raw material MA transported from the raw material accommodation unit 161 and the amount of increase in collected materials collected in the waste powder collecting unit 36. The determination unit 115 identifies, among the raw materials MA for each of which the read unit 113 has read the identification information code MA1, the raw material MA defibrated by the defibration unit 20, and identifies the identification information of the identified raw material MA.

The determination unit 115 may take into account the number of sheets of the raw material MA collected in the collection tray 166 when calculating the number of raw materials MA defibrated by the defibration unit 20. In this case, the determination unit 115 acquires the detected values output by the collected quantity sensor 167 at time T1 and time T2 to calculate the amount of change in the detected values output by the collected quantity sensor 167. The determination unit 115 calculates the quantity or the number of sheets of the raw material MA collected in the collection tray 166 based on the amount of change in the detected values output by the collected quantity sensor 167. The determination unit 115 can calculate more accurately the amount of the raw materials MA transported from the sorting device 16 to the defibration unit 20 by subtracting the quantity or the number of sheets of the raw material MA collected in the collection tray 166 from the quantity or the number of sheets of the raw material MA transported from the raw material accommodation unit 161.

The determination unit 115 may take into account the number of sheets S discharged to the discharge unit 96 when calculating the number of raw materials MA defibrated by the defibration unit 20. In this case, the determination unit 115 acquires the detected values output by the paper discharge quantity sensor 97 at time T1 and time T2 to calculate the quantity of change in the detected values output by the paper discharge quantity sensor 97. The determination unit 115 calculates the quantity or the number of sheets S discharged to the discharge unit 96 based on the quantity of change in the detected values output by the paper discharge quantity sensor 97. The determination unit 115 performs the process based on the quantity or the number of sheets of the raw material MA transported from the raw material accommodation unit 161, the amount of increase in the collected materials collected in the waste powder collecting unit 36, and the quantity or the number of sheets S discharged to the discharge unit 96. The quantity or the number of raw materials MA processed by the defibration unit 20 can be obtained more accurately by this process. Here, the determination unit 115 may calculate the quantity or the number of raw materials MA processed by the defibration unit 20 in consideration of the quantity or the number of sheets of the raw material MA collected in the collection tray 166.

The first storage unit 116 stores the identification information of the raw material MA read by the reading unit 164. The first storage unit 116 stores the identification information of the raw material MA determined by the determination unit 115 to have been defibrated by the defibration unit 20. In addition, the first storage unit 116 may store the identification information of the raw material MA collected in the collection tray 166 under the control of the sorting unit 114.

The first communication unit 117 generates document processing information 330 including the identification information of the raw material MA defibrated by the defibration unit 20 to transmit the generated document processing information 330 to the sheet manufacturing apparatus 100. The document processing information 330 includes identification information 331 of the raw material MA processed by the defibration unit 20. Further, the document processing information 330 may generate the document processing information 330 including a processing date and time 332 indicating the date and time when the raw material MA indicated by the identification information 331 was processed by the defibration unit 20, or the time. The first communication unit 117 corresponds to, for example, a communication unit.

The first communication unit 117 may generate sorting information 340 including the identification information of the raw material MA collected in the collection tray 166 by the sorting unit 114 to transmit the generated sorting information 340 to the server apparatus 200. The sorting information 340 includes identification information 341 of the raw material MA collected in the collection tray 166. The sorting information 340 may generate the sorting information 340 including a sorting date and time 342 indicating the date and time when the raw material MA indicated by the identification information 341 was collected in the collection tray 166 or the time.

The printer 400 includes a printing unit 421, a document information storage unit 422, and a third communication unit 423 as functional units configured by the third controller 410. The function of each of these units is implemented by the cooperation between the hardware and the software when the third processor 411 executes the program. The function of the document information storage unit 422 is implemented by using the storage area of the third memory 412. The function of the third communication unit 423 is implemented by the third processor 411 controlling a communication I/F (not shown).

The third communication unit 423 receives print information 310 transmitted by the PC 500. The print information 310 includes information that prints a document on a print medium by the printer 400. The print information 310 includes identification information 311, a storage deadline 312, a processing deadline 313, and print data 314.

The print data 314 is data of characters and images printed by the printer 400 on a print medium such as PPC paper. The identification information 311 is information to be printed on the print medium together with the print data 314, and is information to be printed on the printed matter of the printer 400 as the identification information code MA1. The storage deadline 312 and the processing deadline 313 are deadlines set for the document printed by the printer 400, and is set automatically, for example, when the operator who operates the PC500 inputs or when the PC 500 generates the print information 310. The storage deadline 312 and the processing deadline 313 are, for example, information indicating a specific date or a specific date and time. The storage deadline 312 indicates a deadline until which the printed document should not be disposed of, and the document is permitted to be processed by the sheet manufacturing apparatus 100 after the storage deadline 312. In other words, it is forbidden to process the document in the sheet manufacturing apparatus 100 before the storage deadline 312 is reached. The processing deadline 313 indicates a deadline by which the printed document should be disposed of, and is required to process the document by the sheet manufacturing apparatus 100 by the processing deadline 313. In other words, it is forbidden to reach the processing deadline 313 without processing the document in the sheet manufacturing apparatus 100. The storage deadline 312 and the processing deadline 313 may not be set. In this case, the PC 500 transmits the print information 310 that does not include the storage deadline 312 and/or the processing deadline 313 to the printer 400.

The printing unit 421 controls the print head and the transport mechanism that transports the print medium, both of which are included in the printer 400, to print characters and images based on the print data 314 to print the identification information code MA1 based on the identification information 311. The document information storage unit 422 stores the identification information 311 of the document printed by the printing unit 421, the storage deadline 312, and the processing deadline 313 in association with each other.

After the printing by the printing unit 421 is completed, the third communication unit 423 generates printed document information 320 based on the information stored in the document information storage unit 422. The printed document information 320 includes identification information 321 of the raw material MA which is a printed document, a storage deadline 322, and a processing deadline 323. When the storage deadline 322 and/or the processing deadline 323 is not stored in the document information storage unit 422, the third communication unit 423 generates the printed document information 320 that does not include the storage deadline 322 and/or the processing deadline 323. The third communication unit 423 transmits the printed document information 320 to the server apparatus 200.

The server apparatus 200 includes a storage deadline management unit 211, a processing deadline management unit 212, a second storage unit 213, and a second communication unit 214 as functional units configured by the second controller 210. The function of each of these units is implemented by the cooperation between the hardware and the software when the second processor 201 executes the program. The function of the second storage unit 213 is implemented by using the storage area of the second memory 202. The function of the second communication unit 214 is implemented by the second processor 201 controlling a communication I/F (not shown).

The second communication unit 214 receives the document processing information 330 and the sorting information 340 which are transmitted by the sheet manufacturing apparatus 100, and the printed document information 320 which is transmitted by the printer 400. The second communication unit 214 extracts the identification information 321, the storage deadline 322, and the processing deadline 323, which are included in the printed document information 320 to store the identification information, the storage deadline, and the processing deadline in the second storage unit 213. The second storage unit 213 corresponds to, for example, a storage unit.

When the storage deadline management unit 211 receives the document processing information 330 from the sheet manufacturing apparatus 100, the storage deadline management unit 211 extracts the identification information 331. The storage deadline management unit 211 refers to the storage deadline stored in the second storage unit 213 in association with the identification information indicated by the identification information 331 to collate the date and time indicated by the processing date and time 332 with the storage deadline. The storage deadline management unit 211 generates document management information 350 including the collation result as a deadline state 352 to transmit the generated document management information 350 to the terminal device 600. The document management information 350 includes identification information 351 of the processed raw material MA and the deadline state 352 indicating whether the storage deadline has been satisfied. For example, when the processing date and time 332 indicates a date and time after the storage deadline, the storage deadline management unit 211 determines that the raw material MA has been processed according to the storage deadline. Further, when the processing date and time 332 indicates a date and time before the storage deadline, the storage deadline management unit 211 determines that the raw material MA has been processed in violation of the storage deadline. These determination results are the deadline state 352.

The processing deadline management unit 212 searches for the identification information corresponding to the identification information 331 included in the document processing information 330 received by the second communication unit 214 from the identification information stored in the second storage unit 213. The processing deadline management unit 212 regards the searched identification information as having been processed. Further, the processing deadline management unit 212 searches for the identification information corresponding to the identification information 341 included in the sorting information 340 received by the second communication unit 214 from the identification information stored in the second storage unit 213. The processing deadline management unit 212 regards the searched identification information as having been processed.

The processing deadline management unit 212 searches for, of the identification information stored in the second storage unit 213, the identification information that has not been processed and whose processing deadline has been passed. The processing deadline management unit 212 generates the document management information 350 including the corresponding identification information to transmit the generated document management information 350 to the terminal device 600. In this case, the document management information 350 includes the searched identification information 351 and the deadline state 352 indicating that the processing deadline has been passed.

When the second communication unit 214 receives the sorting information 340, the second communication unit 214 may transport the received sorting information 340 as the document management information 350 to the terminal device 600. In this case, the identification information 351 is regarded as the identification information 341 included in the sorting information 340. The second communication unit 214 generates a sorting state 353 including the date and time indicated by the sorting date and time 342 and the information indicating that the raw material MA is accommodated in the collection tray 166. The second communication unit 214 generates the document management information 350 including the identification information 351 and the sorting state 353 to transmit the generated document management information 350 to the terminal device 600.

The server apparatus 200 may have a display screen consisting of a liquid crystal display panel or the like. In this case, the second controller 210 may display, on the display screen, the content of the document management information 350 to be transmitted to the terminal device 600. Further, the document management information 350 may be transmitted to a plurality of devices including the terminal device 600, and the transmission mode of the document management information 350 is not limited. For example, the second communication unit 214 may transmit the document management information 350 in the form of an e-mail, may be transmitted as a message to processed by various application programs, or may be transmitted by facsimile.

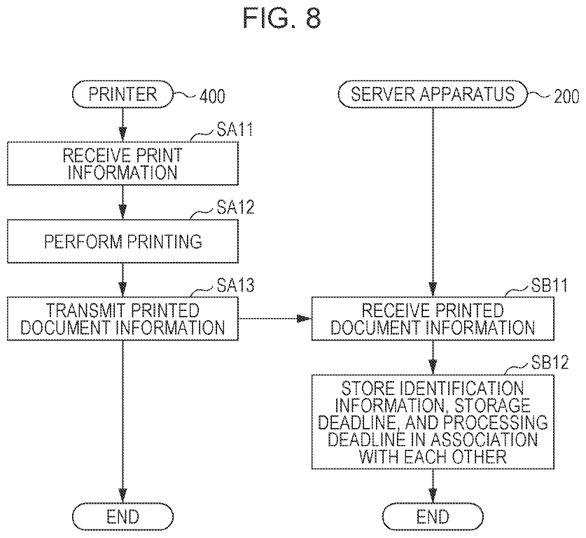

FIG. 8 is a sequence diagram showing the operation of the sheet manufacturing system 1, and shows a mode of transmitting and receiving information between the printer 400 and the server apparatus 200. The operation of FIG. 8 is performed by the third controller 410 and the second controller 210. The operation shown in FIG. 8 is performed, for example, every time the printer 400 prints one raw material MA, every time the number of sheets of the raw material MA printed by the printer 400 reaches a set number of sheets, or every set period.

The third controller 410 receives the print information 310 from the PC 500 (step SA11), and performs printing by the printing unit 421 according to the print data 314 and the identification information 311 included in the print information 310 (step SA12). The third controller 410 generates the printed document information 320 related to the printed document to transmit the generated printed document information 320 to the server apparatus 200 (step SA13).

The second controller 210 receives the printed document information 320 transmitted by the printer 400 (step SB11), extracts the identification information, the storage deadline, and the processing deadline from the printed document information 320, and then stores them in association with each other in the second storage unit 213 (step SB12).

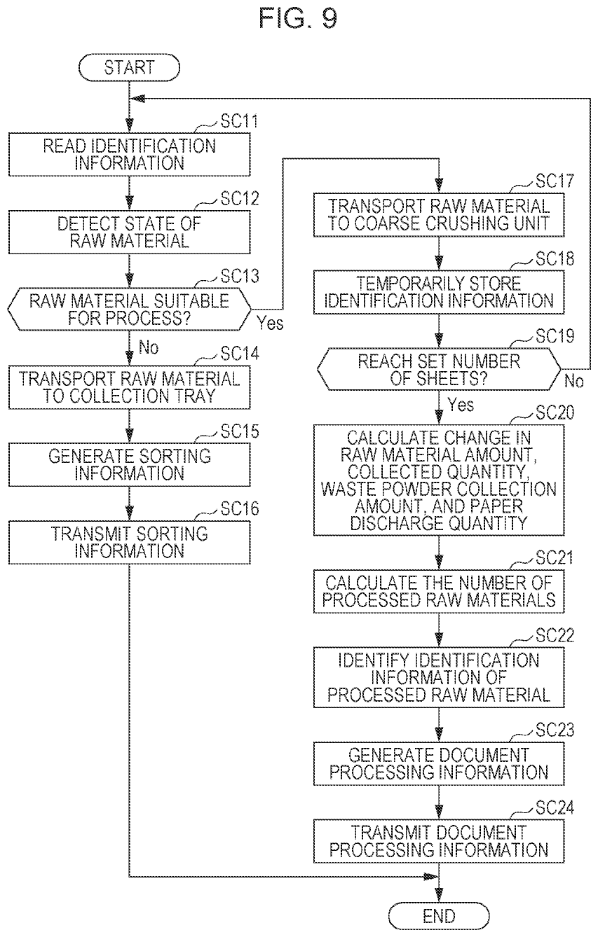

FIG. 9 is a flowchart showing the operation of the sheet manufacturing apparatus 100. The operation shown in FIG. 9 is performed by the first controller 110. The operation of FIG. 9 is performed, for example, every time the sheet manufacturing apparatus 100 takes out one raw material MA from the raw material accommodation unit 161, every time the number of sheets of the raw material MA taken out from the raw material accommodation unit 161 reaches a set number of sheets, or every set period.

The first controller 110 causes the reading unit 164 to read the identification information code MA1 of the raw material MA to acquire the reading result (step SC11). The first controller 110 causes the raw material inspection unit 165 to detect the state of the raw material MA (step SC12).

The first controller 110 determines whether the raw material MA is suitable for the process by the sheet manufacturing apparatus 100 based on the detected value output by the raw material inspection unit 165 (step SC13). When it is determined that the raw material MA is not suitable for the process (step SC13; NO), the first controller 110 operates the switching arm 163C to transport the raw material MA to the collection tray 166 (step SC14). The first controller 110 generates the sorting information 340 including the identification information read in step SC11 (step SC15) to transmit the generated sorting information 340 to the server apparatus 200 (step SC16).

When the first controller 110 determines that the raw material MA is suitable for the process (step SC13; YES), the first controller 110 operates the switching arm 163C to transport the raw material MA to the coarse crushing unit 12 (step SC17). The first controller 110 temporarily stores the identification information read in step SC11 in the first storage unit 116 (step SC18), and determines whether the number of sheets of the raw material MA whose identification information is temporarily stored reaches the set number of sheets (step SC19). Here, when the number of sheets of the raw material MA whose identification information is temporarily stored has not reached the set number of sheets (step SC19; NO), the first controller 110 returns the process to step SC11.

When the number of sheets of the raw material MA whose identification information is temporarily stored reaches the set number of sheets (step SC19; YES), the first controller 110 starts a process of calculating the number of processed raw materials MA. The first controller 110 calculates at least one of the quantity of the raw materials MA in the raw material accommodation unit 161, the quantity of the raw materials MA collected in the collection tray 166, the amount of the collected materials collected in the waste powder collecting unit 36, and the quantity of the sheets S discharged in the discharge unit 96 (step SC20). The first controller 110 calculates the number of raw materials MA processed by the defibration unit 20 based on the quantity calculated in step SC20 (step SC21). The first controller 110 identifies the identification information of the raw material MA processed by the defibration unit 20 based on the number of sheets of the raw material MA obtained in step SC21 and the temporarily stored identification information (step SC22).

The first controller 110 generates the document processing information 330 based on the identification information identified in step SC22 (step SC23) to transmit the generated document processing information 330 to the server apparatus 200 (step SC24).

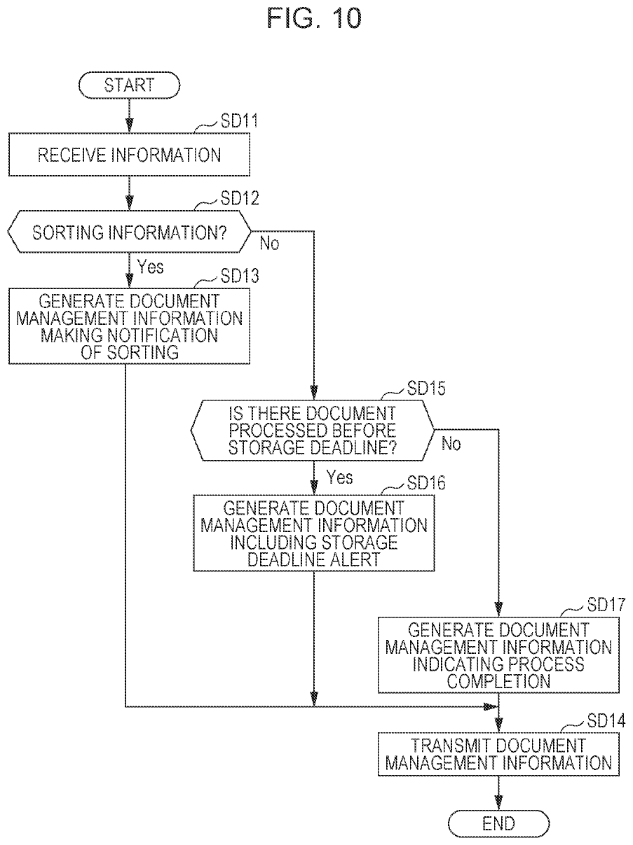

FIG. 10 is a flowchart showing the operation of the server apparatus 200, and shows the operation corresponding to the document processing information 330 and the sorting information 340 transmitted by the sheet manufacturing apparatus 100. The operation shown in FIG. 10 is performed by the second controller 210. The operation of FIG. 10 is performed, for example, every time the server apparatus 200 receives the document processing information 330 or the sorting information 340 from the sheet manufacturing apparatus 100.

When the second controller 210 receives the information transmitted by the sheet manufacturing apparatus 100 (step SD11), the second controller 210 determines whether the received information is the sorting information 340 (step SD12). When the received information is the sorting information 340 (step SD12; YES), the second controller 210 generates the document management information 350 making notification of the sorting (step SD13) to transmit the document management information 350 (step SD14).

When the received information is not the sorting information 340 (step SD12; NO), the received information is the document processing information 330. The second controller 210 collates the identification information 331 and the processing date and time 332 of the document processing information 330 with the storage deadline stored in the second storage unit 213. As described above, the second controller 210 determines presence/absence of the identification information whose processing date and time 332 is earlier than the storage deadline (step SD15). That is, in step SD15, the second controller 210 determines whether there is the raw material MA which is a document processed before the storage deadline.

When there is the raw material MA processed before the storage deadline (step SD15; YES), the second controller 210 generates the document management information 350 including the deadline state 352 indicating that the raw material MA has been processed before the storage deadline (step SD16). The second controller 210 advance the process to step SD14 to transmit the document management information 350.

When there is no raw material MA processed before the storage deadline (step SD15; NO), the second controller 210 generates the document management information 350 indicating the process completion (step SD17). The second controller 210 advance the process to step SD14 to transmit the document management information 350.

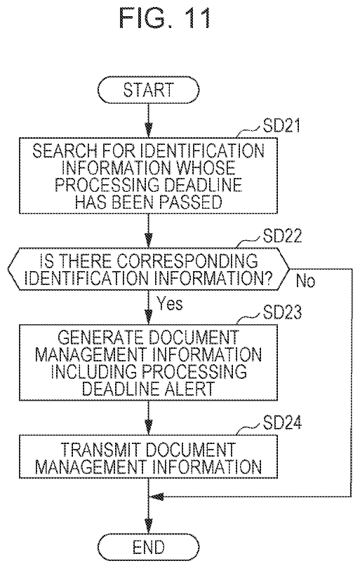

FIG. 11 is a flowchart showing the operation of the server apparatus 200, and shows the operation of detecting the raw material MA whose processing deadline has been passed. The operation shown in FIG. 11 is performed by the second controller 210. The operation of FIG. 11 is performed, for example, every set period.

The second controller 210 searches for, of the identification information stored in the second storage unit 213, the identification information whose processing deadline has been reached and that has not been processed (step SD21). The second controller 210 determines presence/absence of the corresponding identification information (step SD22), and when there is no corresponding identification information (step SD22; NO), the process ends.

When there is the corresponding identification information (step SD22; YES), the second controller 210 generates the document management information 350 including the alarm indicating that the processing deadline has been passed as the deadline state 352 (step SD23). The second controller 210 transmits the generated document management information 350 (step SD24), and the process ends.

### 1-7. Effects of Embodiment

As explained above the sheet manufacturing system 1 according to the first embodiment includes the sheet manufacturing apparatus 100 that decomposes the raw material MA by the defibration unit 20, and the server apparatus 200 that manages a process status of the raw material MA. The sheet manufacturing apparatus 100 includes a reading unit 164 that reads the identification information of the identification information code MA1 attached to the raw material MA and the defibration unit 20 that decomposes the raw material MA whose identification information has been read by the reading unit 164 and that is determined to be suitable for the decomposition process. The sheet manufacturing apparatus 100 includes the determination unit 115 that determines that the raw material MA has been decomposed by the defibration unit 20 and the first communication unit 117 that transmits, to the server apparatus 200, the identification information of the raw material MA determined by the determination unit 115 to have been decomposed by the defibration unit 20.

The document management method performed by the sheet manufacturing system 1 includes the sheet manufacturing apparatus 100 reading the identification information attached to the raw material MA, and decomposing the raw material MA whose identification information has been read. Further, the sheet manufacturing apparatus 100 determines that the raw material MA has been decomposed to transmit, to the server apparatus 200, the identification information of the raw material MA determined to have been decomposed by the defibration unit 20.

According to the sheet manufacturing system 1 to which the present disclosure is applied and the document management method performed by the sheet manufacturing system 1, the raw material MA, which is a document supplied to the sheet manufacturing apparatus 100, can be identified by the identification information, and it can be determined that the identified raw material MA has been decomposed. Then, the server apparatus 200 can acquire the identification information of the raw material MA that has been decomposed. Therefore, it can be confirmed that the document has been processed by the sheet manufacturing apparatus 100. Therefore, it can be confirmed that the information such as characters and images recorded in the document has been substantially erased.

The sheet manufacturing apparatus 100 includes the sorting unit 114 that sorts out the raw material MA suitable for the process by the defibration unit 20, and the first controller 110 can identify the identification information of the raw material MA sorted out by the sorting unit 114. Therefore, the raw material MA suitable for the process by the defibration unit 20 can be managed by the identification information. As a result, it is possible to improve the efficiency of the process of confirming that the information such as characters and images recorded in the document has been substantially erased.

The server apparatus 200 includes the second storage unit 213 that stores the identification information and the processing deadline of the raw material MA in association with each other. The server apparatus 200 includes the processing deadline management unit 212 that manages the processing deadline of the raw material MA based on the identification information, of the raw material MA, received from the sheet manufacturing apparatus 100 and the processing deadline, of the raw material MA, stored in the second storage unit 213. This makes it possible to manage whether the raw material MA has been decomposed by the set processing deadline.

The processing deadline management unit 212 determines, based on the identification information of the raw material MA received from the sheet manufacturing apparatus 100, that the raw material MA has been processed, and identifies a document that is not determined to have been processed by the processing deadline of the raw material MA stored in the second storage unit 213. This makes it possible to discover and manage a document that is not decomposed by the set processing deadline.

The server apparatus 200 stores the identification information and the storage deadline of the raw material MA in association with each other in the second storage unit 213. The server apparatus 200 includes the storage deadline management unit 211 that identifies, based on the identification information, of the raw material MA, received from the sheet manufacturing apparatus 100 and the storage deadline, of the raw material MA, stored in the second storage unit 213, the raw material MA that was processed before the storage deadline. This makes it possible to manage whether the raw material MA has been decomposed before the set storage deadline.

The sheet manufacturing apparatus 100 includes the collection amount sensor 37 that detects a discharged material discharged from the defibration unit 20. The determination unit 115 determines that the raw material MA has been decomposed by the defibration unit 20 based on the detection result output by the collection amount sensor 37. As a result, it is possible to more accurately determine whether the raw material MA has been decomposed by the defibration unit 20 and manage the result.

The sheet manufacturing system 1 includes the printing unit 421 that prints a document, and includes the printer 400 that prints the content of the document and the identification information by the printing unit. The reading unit 164 reads the identification information of the identification information code MA1 printed by the printer 400. As a result, when the document is printed by the printer 400, the identification information code MA1 that can be used for managing the decomposition process by the sheet manufacturing apparatus 100 is printed. Therefore, it is possible to easily manage the process of decomposing the document printed by the printer 400.

Further, the sheet manufacturing apparatus 100 to which the document processing apparatus of the present disclosure is applied includes the reading unit 164 that reads the identification information of the identification information code MA1 attached to the raw material MA and the defibration unit 20 that decomposes the raw material MA whose identification information has been read by the reading unit 164. The sheet manufacturing apparatus 100 includes the determination unit 115 that determines that the raw material MA has been decomposed by the defibration unit 20 and the first communication unit 117 that transmits the identification information of the raw material MA determined by the determination unit 115 to have been decomposed by the defibration unit 20. As a result, the fact that the raw material MA has been decomposed by the sheet manufacturing apparatus 100 can be easily managed by a device capable of receiving the document processing information 330 transmitted by the first communication unit 117.

### 2. Second Embodiment

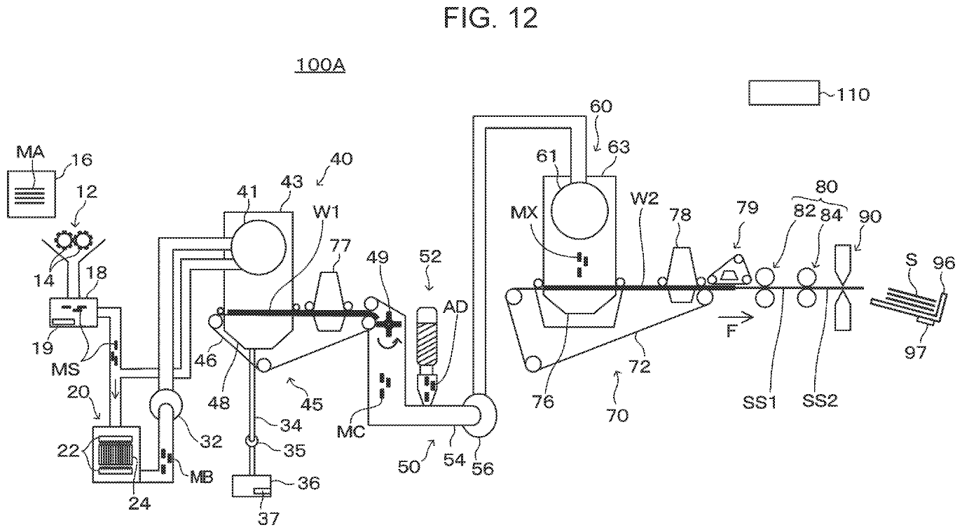

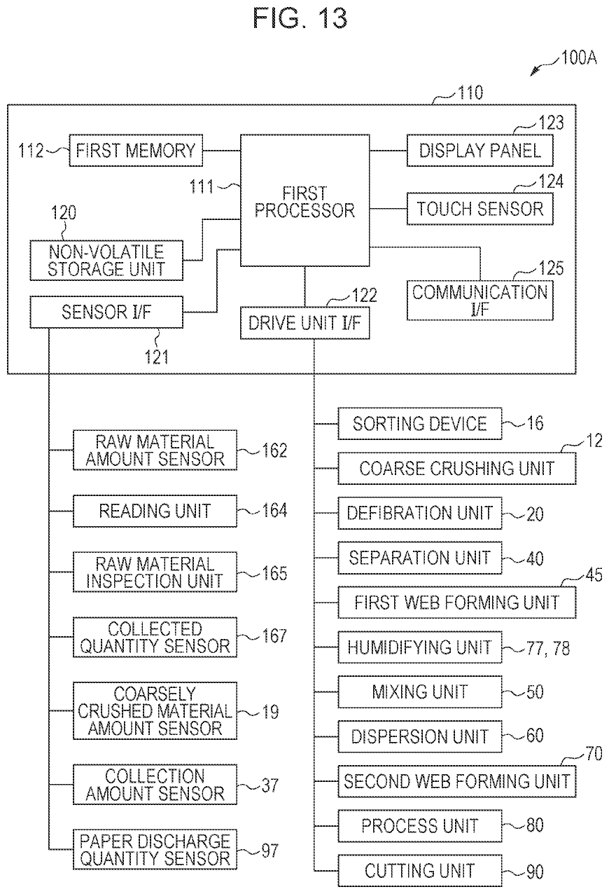

FIG. 12 is a diagram showing the configuration of a sheet manufacturing apparatus 100A of the second embodiment to which the present disclosure is applied. FIG. 13 is a functional block diagram of the sheet manufacturing apparatus 100A. The sheet manufacturing apparatus 100A is an apparatus that can be used in place of the sheet manufacturing apparatus 100 of the sheet manufacturing system 1 described in the first embodiment. The sheet manufacturing apparatus 100A corresponds to, for example, a processing apparatus. Regarding the second embodiment, the same reference numerals are given to the components common to the first embodiment, and the description thereof will be omitted.

In the second embodiment, the coarsely crushed material obtained by coarsely crushing the raw material MA in the coarse crushing unit 12 is indicated by reference numeral MS. As shown in FIG. 12, the sheet manufacturing apparatus 100A includes a coarsely crushed material accommodation unit 18 that temporarily stores a coarsely crushed material MS coarsely crushed by the coarse crushing unit 12. The coarsely crushed material accommodation unit 18 accommodates the coarsely crushed material MS formed by being cut by the coarse crushing blade 14, and discharges the accommodated coarsely crushed material MS toward the defibration unit 20. The coarsely crushed material accommodation unit 18 may include a rotary blade (not shown) that discharges the coarsely crushed material MS and a motor (not shown) that drives the rotary blade.

The coarsely crushed material accommodation unit 18 has a function of stabilizing the supply of the coarsely crushed material MS to the defibration unit 20. For example, in the sorting device 16, when the raw material MA transported by the pickup roller 163A is continuously collected in the collection tray 166, the state in which the raw material MA is not transported from the sorting device 16 to the coarse crushing unit 12 continues. Further, the amount of the coarsely crushed materials MS generated in the coarse crushing unit 12 in a unit time varies depending on the thickness and the size of the raw material MA. As described above, there is a factor that changes the supply amount of the coarsely crushed materials MS from the coarse crushing unit 12 to the defibration unit 20. When the coarsely crushed material accommodation unit 18 is provided, the increase/decrease in the supply amount of the coarsely crushed materials MS from the coarse crushing unit 12 is smoothed by the coarsely crushed material accommodation unit 18 by temporarily storing the coarsely crushed material MS in the coarsely crushed material accommodation unit 18, so that it is possible to supply the coarsely crushed material MS from the coarsely crushed material accommodation unit 18 to the defibration unit 20 at a stable pace.

A coarsely crushed material amount sensor 19 that detects the amount of coarsely crushed materials MS is disposed in the coarsely crushed material accommodation unit 18. The coarsely crushed material amount sensor 19 is a sensor that detects the amount of the coarsely crushed materials MS accommodated in the coarsely crushed material accommodation unit 18, and is, for example, a weight sensor that detects the weight of the coarsely crushed materials MS. Further, the coarsely crushed material amount sensor 19 may be an optical sensor that detects the height of the coarsely crushed material MS accumulated in the coarsely crushed material accommodation unit 18 to the upper end.

As shown in FIG. 13, in the sheet manufacturing apparatus 100A, the coarsely crushed material amount sensor 19 is coupled to the sensor I/F 121 included in the first controller 110. The first controller 110 acquires the detected value output by the coarsely crushed material amount sensor 19, so that it is possible to calculate the amount of the coarsely crushed materials MS temporarily stored in the coarsely crushed material accommodation unit 18 or the change in the amount of the coarsely crushed materials MS.

The first controller 110 includes the determination unit 115 as described in the first embodiment. In step SC20 shown in FIG. 9, the determination unit 115 acquires the detected value output by the coarsely crushed material amount sensor 19 to calculate, based on the acquired detected value, the amount of the coarsely crushed materials

MS transported from the coarsely crushed material accommodation unit 18 to the defibration unit 20. More specifically, the determination unit 115 acquires, for example, the detected values output by the coarsely crushed material amount sensor 19 at reference time T1 and time T2 to calculate, based on the change in the detected values from time T1 to T2, the amount of change in the coarsely crushed materials MS in the coarsely crushed material accommodation unit 18. The amount of the coarsely crushed materials MS accommodated in the coarsely crushed material accommodation unit 18 is increased when the sorting device 16 transports the raw material MA to the coarse crushing unit 12, and is decreased when the coarsely crushed material MS is transported from the coarsely crushed material accommodation unit 18 to the defibration unit 20. The determination unit 115 can calculate more accurately the number of raw materials MA processed by the defibration unit 20 using the amount of change in the coarsely crushed materials MS detected by the coarsely crushed material amount sensor 19, the number of sheets of the raw material MA transported by the sorting device 16 to the coarse crushing unit 12, and the amount of change in the collected materials detected by the collection amount sensor 37.

Instead of the sheet manufacturing apparatus 100, the sheet manufacturing apparatus 100A described in the second embodiment in the sheet manufacturing system 1 is provided, so that it is possible to obtain the same effects as that of the first embodiment described above. Further, it is possible to stabilize the supply of the coarsely crushed material MS to the defibration unit 20, and to manufacture the sheet S with higher quality. Further, the number of raw materials MA processed by the defibration unit 20 can be accurately obtained by using the detected value output by the coarsely crushed material amount sensor 19.

### 3. Third Embodiment

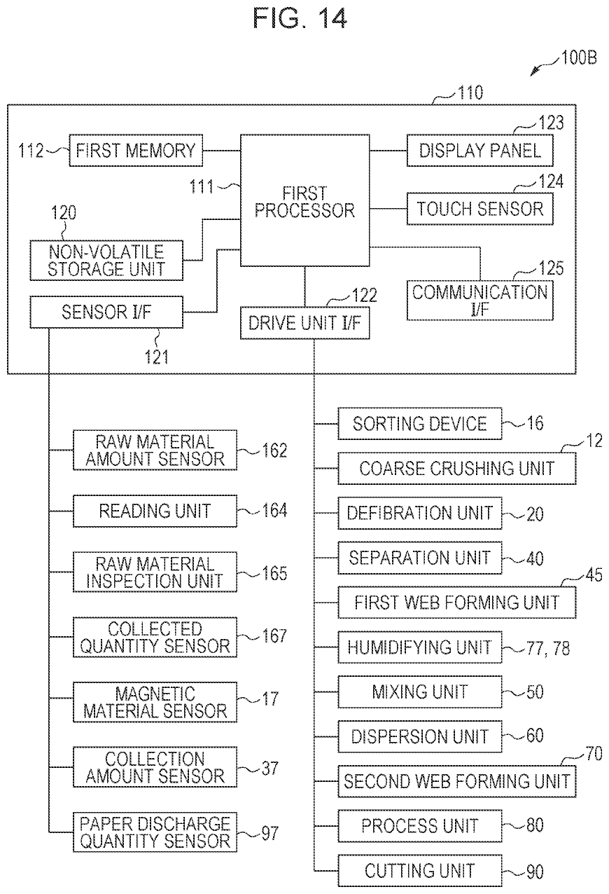

FIG. 14 is a functional block diagram of a sheet manufacturing apparatus 100B of the third embodiment. The sheet manufacturing apparatus 100B is an apparatus that can be used in place of the sheet manufacturing apparatus 100 of the sheet manufacturing system 1 described in the first embodiment. The sheet manufacturing apparatus 100B corresponds to, for example, a processing apparatus. Regarding the third embodiment, the same reference numerals are given to the components common to the first embodiment, and the description thereof will be omitted.

The sheet manufacturing apparatus 100B includes a magnetic material sensor 17. The magnetic material sensor 17 is provided in a pipe through which the defibrated product MB discharged by the defibration unit 20 is transported, or in a discharge port through which the defibration unit 20 discharges the defibrated product MB. The magnetic material sensor 17 is a sensor that detects a magnetic material such as metal, and is composed of, for example, a magnetic sensor. Further, a metal detector may be used instead of the magnetic material sensor 17.

The sheet manufacturing apparatus 100B has a function of detecting that the security paper has been defibrated by the defibration unit 20 when the sorting device 16 transports the raw material MA which is the security paper to the coarse crushing unit 12. The security paper is paper which is watermarked with a magnetic wire, and is used for the purpose of strengthening security. When an alternating magnetic field of a predetermined frequency is applied to the security paper, the magnetic wire with which the paper is watermarked emits a steep pulse signal when the magnetization is inverted. It is possible to detect the presence of paper including the magnetic wire by detecting this pulse signal with a detection device. Therefore, it is possible to detect the carry-in or take-out of the security paper by installing a detection device that generates an alternating magnetic field at the entrance/exit of a building or a room. Therefore, the security paper is used to print a document whose carry-in or take-out needs to be restricted or controlled.

When the security paper as the raw material MA is transported to the coarse crushing unit 12, coarsely crushed pieces including a magnetic wire are generated in the coarse crushing unit 12. Since the defibration unit 20 defibrates the coarsely crushed pieces including the magnetic wire, the defibrated product MB discharged by the defibration unit 20 contains magnetic particles obtained by crushing the magnetic wire. The sheet manufacturing apparatus 100B can determine that the security paper has been defibrated by the defibration unit 20 by detecting the magnetic particles by the magnetic material sensor 17.

Further, the sorting device 16 may include the raw material inspection unit 165 including a magnetic material sensor. In this case, the first controller 110 can determine that the sorting device 16 has transported the security paper to the defibration unit 20. Further, the first controller 110 can identify the identification information of the raw material MA which is the security paper from the reading result of the reading unit 164. As a result, the first controller 110 can identify the identification information of the security paper transported toward the defibration unit 20 to accurately determine that the security paper has been defibrated by the defibration unit 20.

The magnetic material sensor 17 may be provided in a pipe or the like through which the coarsely crushed material crushed by the coarse crushing unit 12 is transported toward the defibration unit 20, and may detect the magnetic material contained in the coarsely crushed material. In this case, the first controller 110 can accurately determine that the security paper has been cut by the coarse crushing unit 12.

Instead of the sheet manufacturing apparatus 100, the sheet manufacturing apparatus 100B described in the third embodiment in the sheet manufacturing system 1 is provided, so that it is possible to obtain the same effects as that of the first embodiment described above. Further, when the security paper as the raw material MA is set in the raw material accommodation unit 161, it can be more accurately determined that the raw material MA which is a security paper has been processed by the coarse crushing unit 12 or the defibration unit 20.

### 4. Other Embodiments

Each of the above-described embodiments is merely a specific embodiment of the present disclosure described in the claims, and does not limit the present disclosure, and as long as it does not deviate from the gist it can be carried out in various embodiments, for example, as shown below.

For example, in each of the above embodiments, the function of the server apparatus 200 may be implemented in the sheet manufacturing apparatus 100 or the printer 400. That is, the process and operation performed by the second controller 210 may be performed by the first controller 110 or the third controller 410. Further, part of the process performed by the first controller 110 may be performed by the second controller 210, and the configuration of the sheet manufacturing system 1 is not limited to the embodiments exemplified in the above embodiments. Further, in each of the above embodiments, the identification information code MA1 read by the reading unit 164 may be formed of ink or toner that can be visually recognized by visible light, or it may be detectable by irradiation with visible external light such as ultraviolet light.

Each functional unit shown in FIGS. 1, 6, 7, 13 and 14 indicates a functional configuration, and a specific implementation form is not particularly limited. That is, it is not always necessary to implement hardware corresponding to respective functional units, but it is of course possible to construct a configuration in which the functions of a plurality of functional units are implemented by executing a program by one processor. In addition, in the above embodiment, part of the functions implemented by software may be implemented by hardware, or part of the functions implemented by hardware may be implemented by software. In addition, specific detailed configurations of other sections of the sheet manufacturing apparatus 100 can be changed in any manner without departing from the scope of the present disclosure.

The processing stages of the flowchart shown in FIGS. 9 to 11 are divided in accordance with the main processing contents in order to make the process of each unit of the sheet manufacturing system 1 easy to understand. The embodiments are not limited by the division method or the name of these processing stages shown in these flowcharts, and can be divided into more processing stages depending on the processing content or can be divided so that one processing stage includes many more processes. Further, the order of processing in the flowcharts is not limited to the illustrated example.

Further, the programs performed by the first controller 110, the second controller 210, and the third controller 410 may be stored in respective devices, or may be recorded on a recording medium that is readable by a computer. Examples of the recording medium may include a magnetic or optical recording medium or a semiconductor memory device. In addition, the program corresponding to each of the above devices is stored in the server apparatus or the like, and the program is downloaded from the server apparatus to each unit, so that the operation of the sheet manufacturing system 1 can also be implemented.

What is claimed is:

1. A document management system comprising:
a processing apparatus that decomposes a document; and
a management apparatus that manages a process status of the document, wherein
the processing apparatus includes
a read unit that reads identification information attached to the document,
a processing unit that decomposes the document the identification information of which was read by the read unit and that is determined to be suitable for a decomposing process,
a determination unit that determines that the document was decomposed by the processing unit, and
a communication unit that transmits, to the management apparatus, identification information of the document determined by the determination unit to have been decomposed by the processing unit.

2. The document management system according to claim 1, wherein
the processing apparatus includes a sorting unit that sorts the document suitable for a process by the processing unit, and
the processing apparatus is configured to identify identification information of the document sorted by the sorting unit.

3. The document management system according to claim 1, wherein
the management apparatus includes
a storage unit that stores identification information of the document in association with a processing deadline of the document, and
a processing deadline management unit that manages, based on identification information of the document received from the processing apparatus and the processing deadline of the document stored in the storage unit, the processing deadline of the document.

4. The document management system according to claim 3, wherein
the processing deadline management unit
determines, based on the identification information of the document received from the processing apparatus, that the document was processed, and
identifies the document that is not determined to have been processed by the processing deadline of the document stored in the storage unit.

5. The document management system according to claim 1, further comprising:
a storage deadline management unit
that stores identification information of the document in association with a storage deadline of the document in the storage unit, and
that identifies, based on identification information of the document received from the processing apparatus and the storage deadline of the document, stored in the storage unit, the document that was processed before the storage deadline of the document.

6. The document management system according to claim 1, wherein
the processing apparatus includes a discharge detection unit that detects a discharged material discharged from the processing unit, and
the determination unit determines, based on a detection result by the discharge detection unit, that the document was decomposed by the processing unit.

7. The document management system according to claim 1, further comprising:
a printing device including a printing unit that prints the document, the printing unit printing a content of the document and the identification information of the document, wherein
the read unit reads the identification information of the document printed by the printing device.

8. A document management method in which a processing apparatus that decomposes a document and a management apparatus that manages a process status of the document are used, the method comprising:
by the processing apparatus,
reading identification information attached to the document;
decomposing the document the identification information of which was read;
determining that the document was decomposed; and
transmitting, to the management apparatus, the identification information of the document determined to have been decomposed.

9. A document processing apparatus comprising:
a read unit that reads identification information attached to a document;
a processing unit that decomposes the document the identification information of which was read by the read unit;
a determination unit that determines that the document was decomposed by the processing unit; and
a communication unit that transmits the identification information of the document determined by the determination unit to have been decomposed by the processing unit.
